(19) United States
(12) Patent Application Publication
(10) Pub. No.: US 2010/0038888 A1
(43) Pub. Date: Feb. 18, 2010

(54) Airbag fastening in an airbag module

(75) Inventor: Stefan Hamels, Aschaffenburg (DE)

Correspondence Address: FOLEY AND LARDNER LLP;SUITE 500, 3000 K STREET NW, WASHINGTON, DC, 20007, US

(73) Assignee: TAKATA-PETRI AG

(21) Appl. No.: 12/588,450

(22) Filed: Oct. 15, 2009

Related U.S. Application Data
(63) Continuation of application No. PCT/EP2008/056536, filed on May 28, 2008.

(30) Foreign Application Priority Data
Jun. 4, 2007 (DE) 20 2007 007 885.4

(51) Int. Cl. B60R 21/16

(52) U.S. Cl. 280/728.2

(57) ABSTRACT

An airbag fastening in an airbag module is provided. The airbag fastening comprising a generator support an airbag with an inflation opening, wherein the airbag module has at least one side wall, and at least one deformable mechanical element for connecting the generator support to the side wall. The airbag module has at its side wall clamp jaws for fastening the airbag in the region of its inflation opening and the deformable mechanical elements are provided on the generator support and act upon at least one of the clamp jaws.

### CROSS-REFERENCE TO RELATED PATENT APPLICATION

This application is a Continuation of International Application PCT/EP2008/056536, filed May 28, 2008, which was published in German on Dec. 11, 2008, as WO 2008/148676 A1. The foregoing International Application is incorporated herein by reference in its entirety.

### BACKGROUND

The application relates to an airbag fastening in an airbag module.

It is known from DE 198 04 579 A1 and from the U.S. Pat. No. 5,709,401 to connect the generator support, the airbag and the cover cap in the airbag module by means of hooks. To this end, on a side edge of the cover cap and in the region of the inflation opening of the airbag, slots are present, in which, during assembly, hooks engage on the generator support. For securement, these hooks are bent over after the assembly of the said three components.

This arrangement has the disadvantage, that the hooks clamp the folded airbag. Therefore, the danger exists that in case of a vacuum-folded airbag wrapped in a foil this foil would be damaged by the hooks.

### SUMMARY

An object of a disclosed embodiment is to fasten the airbag in an airbag module by the means of latching elements such that the airbag or the foil enclosing it are not directly clamped by latching elements.

In an airbag fastening in an airbag module having a generator support, having an airbag with an inflation opening, whereby the airbag module has at least one side wall and having at least one deformable mechanical element for connecting the generator support to the side wall the airbag module has at its side wall clamp jaws for fastening the airbag in the region of its inflation opening and the deformable mechanical elements are provided on the generator support and act upon at least one of the clamp jaws. One of the airbag caps is preferably provided as a side wall and latching elements or such elements which are externally plastic deformable are preferably provided as deformable mechanical elements.

This arrangement has the advantage that due to the fastening of the airbag together with, if applicable, the airbag enclosing foil by the means of clamp jaws the danger of damaging the foil or the airbag by the latching elements does not exist anymore. Due to the impact of the deformable mechanical elements on one of the clamp jaws the direct clamping of the airbag and therefore also the impact on the airbag enclosing foil is omitted.

Exemplary, the airbag has at least one clamp element extending outwardly to which distantly superposed clamp jaws extending inwardly are assigned as at least one clamp jaw pair which is clampable between the generator support and the deformable mechanical elements.

The deformable mechanical elements are preferably arranged at a side wall of the generator support running nearly parallel to the respective side wall of the airbag cap and each deformable mechanical element is assigned to an upper clamp jaw of the airbag cap through openings in the side wall of the airbag cap. Additionally, the upper clamp jaw can have a stopper located between the airbag and the deformable mechanical element so that also a contact of the airbag by the deformable mechanical elements is excluded.

In order to facilitate an easy inserting of the airbag between the clamp jaws the airbag cap is elastically deformable in the section of the clamp jaws. For this purpose it is expedient that the side wall of the airbag cap has vertical slots.

The clamp element can be differently designed. Thus, it can be a part of a diffuser arranged between the gas generator and the airbag. However, a separated part can also be provided as a clamp element. Preferably, a clamp ring which can additionally have a tubular section extending into the airbag is provided as a clamp element.

### BRIEF DESCRIPTION OF THE DRAWINGS

The invention is intended to be described in exemplary embodiments with reference to figures in which:

FIG. 1 shows a section through a segment of an airbag module with a first embodiment of a clamp ring as clamp element.

FIG. 2 shows a section through a segment of an airbag module with a second embodiment of the clamp ring as clamp element.

FIG. 3 shows a section through an airbag cap.

### DETAILED DESCRIPTION

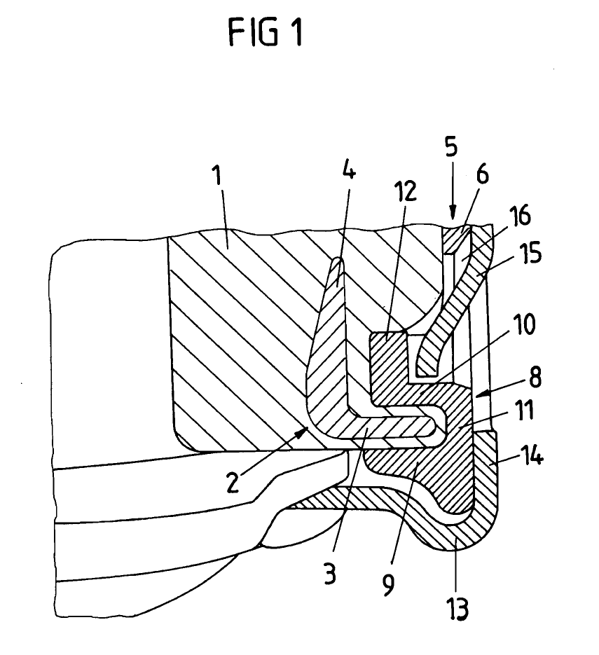

FIG. 1 shows an airbag 1 with an integrated clamp ring 2 having a horizontal, circular section 3 and a tubular section 4. The clamp ring 2 is for instance sewn into an airbag 1. An airbag cap 5 has a revolving side wall 6 and spaced slots 8 running in case of a rectangular layout of the side wall preferably in the corners in the direction of the upper cover 7 of the airbag cap (FIG. 3). These slots guarantee that every section of the side wall 6 is elastically deformable during the assembly of the airbag 1.

At the lower end of the side wall 6 at least one clamp jaw pair is provided having a lower clamp jaw 9 and an upper clamp jaw 10 connected by a bar 11. The upper clamp jaw 10 has a stopper 12.

Furthermore, a generator support 13 is provided having at least one side wall 14 with latching elements or with externally plastic deformable mechanical elements of which in FIG. 1 a latching element or an externally deformable mechanical element 15 is shown in a section. To each an opening 16 is assigned in the side wall 6 of the airbag cap 5.

The assembly of the airbag is conducted in such a manner that the folded airbag 1 with the clamp ring 2 sewn into it in the region of its inflation opening is inserted into the airbag cap 5 as an airbag package which is vacuum-packed into a foil not shown in the Figures. Thereby due to the slots 8 in the side wall 6 of the airbag cap 5 it is possible that the side wall is section-wise elastically bent outwards in order to facilitate the insertion of the circular section 3 of the clamp ring 2 between the clamp jaws 9, 10. This unit consisting of airbag cap 5 and the airbag package 1 is integrated in the following into the generator support 13. By this, the latching elements 15 extending inwardly are elastically pushed outwards trough the side wall 6 of the airbag cap 5 until they can spring back through the openings 16 in the side wall 6 of the airbag cap 5 and then lie on the upper clamp jaw 10 and by this the generator support 13 is snapped with the airbag cap 5 as well as the airbag package 1 is clamped between the clamp jaws 9, 10. Since the clamping occurs between the latching elements 15 and the appropriate upper clamp jaw 10 a damage of the package foil or the airbag by the latching elements is excluded. The additionally provided stoppers 12 additionally prevent any contact of the latching elements 15 with the air package 1.

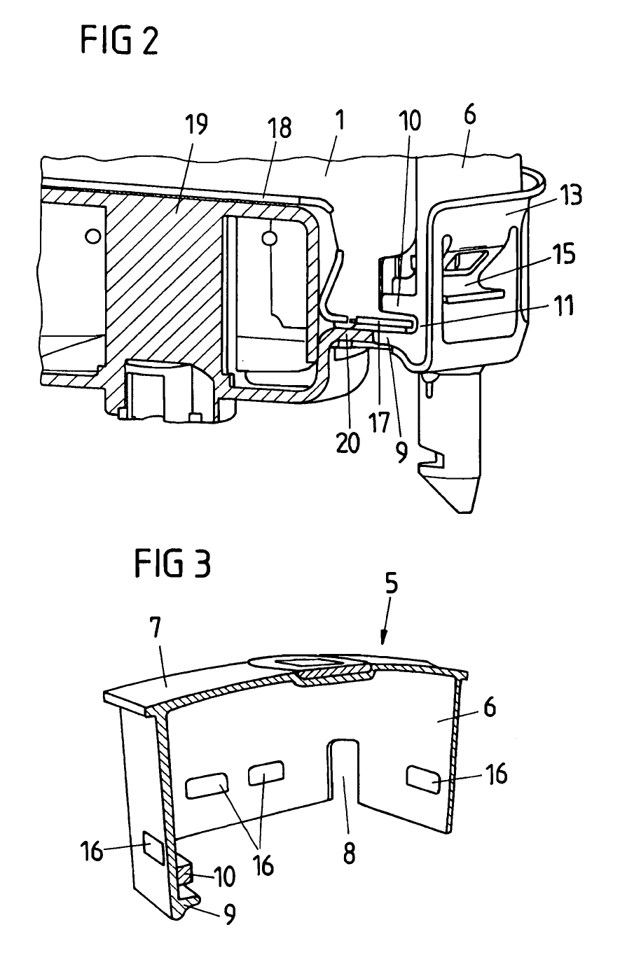

In the embodiment according to FIG. 2 in the place of the separate clamp ring a circular section 17 of a diffuser 18 is provided enclosing a gas generator 19. The airbag 1 encloses the circular section 17 in the area of its inflation opening and is clamped between the lower and the upper clamp jaws 9, 10. Additionally, the circular section 17 adjacent to the lower clamp jaw 9 bears on a generator flange 20.

In the sectional view through the airbag cap 5 demonstrated in FIG. 3 clamp jaws 9, 10 are only shown on the left side. However, they are at least provided in the area of the opening 16.

The priority application, German Patent Application 20 2007 007 885.4, filed Jun. 4, 2007, including the specification, drawings, claims and abstract, is incorporated herein by reference in its entirety.

What is claimed is:

1. An airbag fastening in an airbag module having a generator support, having an airbag with an inflation opening, wherein the airbag module has at least one side wall, and having at least one deformable mechanical element for connecting the generator support to the side wall, wherein the airbag module has at its side wall clamp jaws for fastening the airbag in the region of its inflation opening and that the deformable mechanical elements are provided on the generator support and act upon at least one of the clamp jaws.

2. The airbag fastening as claimed in claim 1, wherein as a side wall the one of an airbag cap is provided.

3. The airbag fastening as claimed in claim 1, wherein as deformable mechanical elements latching elements are provided.

4. The airbag fastening as claimed in claim 1, wherein as deformable mechanical elements such elements are provided which are externally plastic deformable.

5. The airbag fastening as claimed in claim 1, wherein the airbag has at least one clamp element extending outwardly to which at least one clamp jaw pair is assigned, whereby the clamp jaw pair consists of distantly superposed clamp jaws extending inwardly, whereby the clamp jaw pair is clampable between the generator support and the deformable mechanical elements.

6. The airbag fastening as claimed in claim 5, wherein deformable mechanical elements are arranged at a side wall of the generator support running nearly parallel to the respective side wall of the airbag cap and each mechanical element is assigned to an upper clamp jaw of the airbag cap through openings in the side wall of the air bag cap.

7. The airbag fastening as claimed in claim 6, wherein each upper jaw clamp has a stopper located between the airbag and the deformable mechanical element.

8. The airbag fastening as claimed in claim 1, wherein the side wall of the airbag cap is elastically deformable in the region of the clamp jaws.

9. The airbag fastening as claimed in claim 8, wherein the side wall of the airbag cap has vertical slots.

10. The airbag fastening as claimed in claim 1, wherein the clamp element is part of a diffuser arranged between a gas generator and the airbag.

11. The airbag fastening as claimed in claim 1, wherein as clamp element a separate part is provided.

12. The airbag fastening as claimed in claim 1, wherein as clamp element a clamp ring is provided.

13. The airbag fastening as claimed in claim 12, wherein the clamp ring has a tubular section.
